(19) United States
(12) Patent Application Publication
(10) Pub. No.: US 2010/0042464 A1
(43) Pub. Date: Feb. 18, 2010

(54) Method and Apparatus for Guaranteed Delivery of Ads on an Exchange

(76) Inventors: Sundar Seshadri, Santa Clara, CA (US); Robert van Gent, Redwood City, CA (US); Dirk Reinshagen, San Mateo, CA (US); Venkatesh B. Natrajan, San Jose, CA (US); Jeff Gill, Fremont, CA (US)

Correspondence Address: Stattler-Suh PC, 60 SOUTH MARKET, SUITE 480, SAN JOSE, CA, 95113, US

(21) Appl. No.: 12/190,135

(22) Filed: Aug. 12, 2008

(51) Int. Cl. G06Q 30/00; G06Q 10/00

(52) U.S. Cl. 705/10; 705/7; 705/26; 705/14.48

(57) ABSTRACT

A method and apparatus are provided for guaranteed delivery of ads on an exchange. In one example, the method includes determining all valid paths originating from a buyer and ending at one or more sellers, applying one or more controls to the valid paths in order to trim the valid paths according to criteria of the one or more controls, determining available inventory including available spots on web pages of sellers, and making ad reservations for the buyer based on the available inventory and the valid paths.

### FIELD OF THE INVENTION

The present invention relates to delivery of web ads. More particularly, the present invention relates to guaranteed delivery of web ads on an exchange.

### BACKGROUND OF THE INVENTION

Electronic exchanges, including online auctions and guaranteed deliveries, have proliferated along with the Internet. These electronic exchanges aim to provide a high degree of trading efficiency by bringing together a large number of buyers and sellers. Such exchanges are focused on directly matching the bids and offers of buyers and sellers. Conventional transactions on the exchange are between (i) buyers and sellers, (ii) intermediaries (e.g., brokers, which may be a buyer or seller), or (iii) buyers or sellers and intermediaries.

The proliferation of Internet activity has also generated tremendous growth for advertising on the Internet. Typically, advertisers (i.e., buyers of ad space) and online publishers (sellers of ad space) have agreements with one or more advertising networks (ad networks), which provide for serving an advertiser's banner or ad across multiple publishers, and concomitantly provide for each publisher having access to a large number of advertisers. Ad networks (which may also manage payment and reporting) may also attempt to target certain Internet users with particular advertisements to increase the likelihood that the user will take an action with respect to the ad. From an advertiser's perspective, effective targeting is important for achieving a high return on investment (ROI).

Online advertising markets exhibit undesirable inefficiencies when buyers and sellers are unable to transact. For instance, although a publisher may be subscribed to many ad networks, and one or more of those ad networks may transact inventory with other ad networks, only one of the ad networks to which the publisher is subscribed will be involved in selling (e.g., auctioning or guaranteeing delivery) a given ad space for the publisher. The publisher, or a gatekeeper used by the publisher, selects or prioritizes which ad network (or advertiser having a direct agreement with the publisher) will serve the impression for a given ad request.

Within this document, one of ordinary skill recognizes certain abbreviations such as, for example, cost per impression (CPI), Cost Per Mil, or cost per 1000 impressions (CPM), cost per click (CPC), cost per acquisition (CPA), effective CPM (eCPM).

### SUMMARY OF THE INVENTION

What is needed is an improved method having features for addressing the problems mentioned above and new features not yet discussed. Broadly speaking, the present invention fills these needs by providing a method and apparatus for guaranteed delivery of ads on an exchange. It should be appreciated that the present invention can be implemented in numerous ways, including as a method, a process, an apparatus, a system or a device. Inventive embodiments of the present invention are summarized below.

In one embodiment, a method of guaranteed delivery of ads on an exchange is provided. The method comprises determining all valid paths originating from a buyer and ending at one or more sellers, applying one or more controls to the valid paths in order to trim the valid paths according to criteria of the one or more controls, determining available inventory including available spots on web pages of sellers, and making ad reservations for the buyer based on the available inventory and the valid paths.

In another embodiment, a business platform apparatus for guaranteed delivery of ads on an exchange is provided. The business platform apparatus is configured for determining all valid paths originating from a buyer and ending at one or more sellers, applying one or more controls to the valid paths in order to trim the valid paths according to criteria of the one or more controls, determining available inventory including available spots on web pages of sellers, and making ad reservations for the buyer based on the available inventory and the valid paths.

In still another embodiment, a computer readable medium carrying one or more instructions for guaranteed delivery of ads on an exchange is provided. The one or more instructions, when executed by one or more processors, cause the one or more processors to perform the steps of determining all valid paths originating from a buyer and ending at one or more sellers, applying one or more controls to the valid paths in order to trim the valid paths according to criteria of the one or more controls, determining available inventory including available spots on web pages of sellers, and making ad reservations for the buyer based on the available inventory and the valid paths.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1A illustrates exchange entities, which include several exemplary entities that participate in an ad exchange, in accordance with an embodiment of the present invention;

FIG. 1B illustrates a user cookie space that has some stored segment identifiers, in accordance with an embodiment of the present invention;

FIG. 2 is a block diagram of a system for guaranteed delivery of ads on an exchange, in accordance with an embodiment of the present invention;

FIG. 3 is a more detailed block diagram of the exchange system of FIG. 2, in accordance with an embodiment of the present invention; and

FIG. 4 is a flowchart of a method for guaranteed delivery of ads on an exchange, in accordance with an embodiment of the present invention.

### DETAILED DESCRIPTION OF THE INVENTION

An invention for guaranteed delivery of ads on an exchange is disclosed. Numerous specific details are set forth in order to provide a thorough understanding of the present invention. It will be understood, however, to one skilled in the art, that the present invention may be practiced with other specific details.

### Non-Guaranteed Delivery in an Exchange

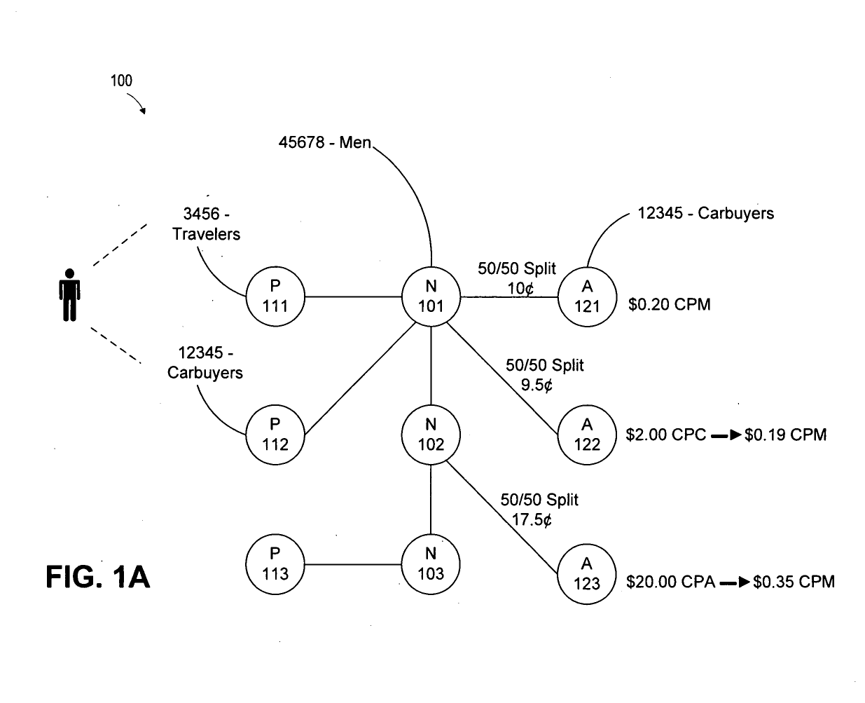

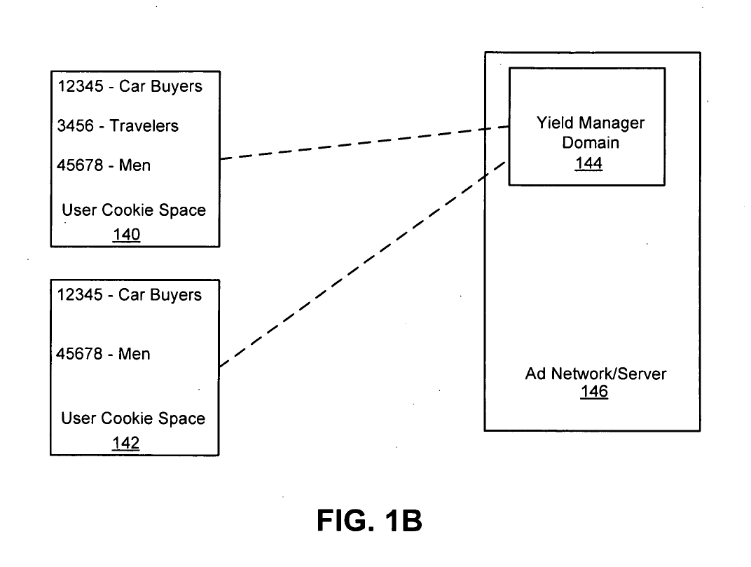

FIG. 1A illustrates exchange entities 100, which include several exemplary entities that participate in an ad exchange, in accordance with an embodiment of the present invention. As shown in this figure, the entities include ad networks 101, 102, 103, publishers 111, 112, 113, and advertisers 121, 122, 123. Examples of ad networks include Yahoo!® Ad Network and MediaNews Group®. One of ordinary skill recognizes that the foregoing entities are exemplary and that the exchange entities 100 may contain other ad networks, publishers, advertisers, and/or other entities.

The publishers 111, 112, 113 preferably have content that is of interest to consumers of such content. For instance, the publisher 112 may have a web page such as Edmunds.com that is directed to car buyers. Users of the Internet may visit the web page to obtain the content provided. Some embodiments log the visits and/or activities of the users on the web page, and further generate segments of users who interact with the content. As shown in the figure, the publisher 111 may have content for travelers, while the publisher 112 has content for car buyers. Each segment preferably has a unique identifier that is unique to the segment, and is also unique to the entity. In this example, the segment “Car Buyers” for the publisher 112 is assigned the identifier “12345,” the segment “Travelers” for the publisher 111 is assigned the identifier “3456,” and the segment “Men” is assigned the identifier “45678” for the ad network 101.

As users and/or segments of users interact with the content provided by the publishers 111, 112, 113, “ad calls” are generated for the publishers' advertising inventory. Generally, in non-guaranteed delivery, the advertisers 121, 122, 123, bid to supply advertising to the available inventory. In this example, the advertiser 121 bids $0.20 CPM, the advertiser 122 bids $2.00 CPC, and the advertiser 123 bids $20.00 CPA. Some systems normalize the bids and/or costs to CPM. Hence, the $2.00 CPC may be normalized to $0.19 CPM, and the $20.00 CPA to $0.35 CPM. Further, the advertisers 121, 122, 123 may have split fee arrangements with the ad networks 101, 102, 103. FIG. 1A illustrates 50/50 split fee arrangements between each advertiser 121, 122, 123, and each ad network 101, 102, 103. More specifically, for the $0.20 CPM the advertiser 121 pays for presentation of its advertising to users/consumers, the advertiser pays $0.10 CPM to the ad network 101. Other fee arrangements, however, are recognized by one of ordinary skill.

The advertisers 121, 122, 123 typically have advertising campaigns that include one or more ad creatives that promote a particular brand or product. The advertisers 121, 122, 123 may wish to specify certain criteria for each campaign such as, for example, maximum spend per day on the delivery of advertising, and/or criteria for targeted advertising. Examples of “hard targeting” include directing an advertisement to a particular gender and/or during a particular time of day. The advertisers 121, 122, 123 may further target particular users and/or segments of users. Particular transactions and/or data have additional value for the exchange entities 100. For instance, one or more ads and/or campaigns for the advertiser 121 may have particular relevance to the Car buyers 12345.

In one implementation, an ad manager server maintains a history of attributes for several advertisements, and predicts the value per advertisement in relation to each publisher. The ad server may perform the foregoing alternatively, or in conjunction with, behavioral type targeting based on user data. In some of these embodiments, each user has a cookie space that is used by various entities to store information. For instance, one or more entities of the exchange entities 100 advantageously write into a user's cookie space an integer identifier that corresponds to a particular user segment.

FIG. 1B illustrates a user cookie space 142 that has some stored segment identifiers, in accordance with an embodiment of the present invention. Examples of stored segment identifiers include 12345-CarBuyers, 3456-Travelers, and 45678-Men, that are advantageously used to target and/or generate the users/segment(s).

### Guaranteed Delivery in an Exchange

The purpose of the present invention is to guarantee delivery such that advertisers do not bid as in FIG. 1A. Rather, advertisers and their intermediaries establish contracts before delivery so that ad delivery by the publisher is guaranteed.

The exchange for guaranteed deliver is represented as a directed graph of nodes, similar to that of FIG. 1A. Relationships between entities may be arranged as described above with reference to FIG. 1A. Each node represents an entity doing business on the exchange. An ad-delivery transaction on the exchange involves traversing this directed graph. An ad-delivery transaction originates from an entity (buyer) and terminates at an entity (seller). For example, the advertiser 121 (e.g., Nike®) may want to advertise with the publisher 113 (e.g., MercuryNews.com).

The connection between the buyer and seller may be referred to as a path on the exchange. This path could go through zero or more other entities on the exchange, each of which is considered to be an intermediary in the transaction. This path comprises one or more edges. Each edge has a buyer endpoint (an entity) and a seller end-point (another entity). The buyer endpoint of the first such edge is the original buyer (advertiser) in the ad delivery transaction. The seller end-point of the last such edge is the original seller (publisher) in the ad-delivery transaction. An example of an edge is the connection between the ad network 101 and the ad network 102, or the connection between the advertiser 121 and the ad network 101.

### Architecture Overview of Guaranteed Delivery

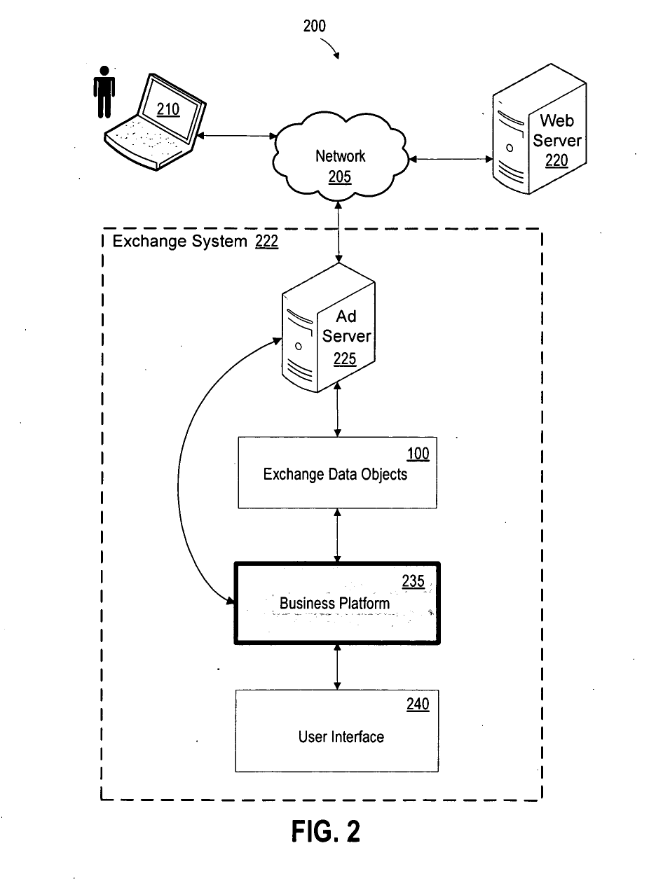

FIG. 2 is a block diagram of a system 200 for guaranteed delivery of ads on an exchange, in accordance with an embodiment of the present invention. A device of the present invention is hardware, software or a combination thereof. A device may sometimes be referred to as an apparatus. Each device is configured to carry out one or more steps of the method of guaranteed delivery of ads on an exchange.

The network 205 couples together a consumer computer 210, a web server 220 and an exchange system 222. The network 205 may be any combination of networks, including without limitation the Internet, a local area network, a wide area network, a wireless network and a cellular network. The consumer computer 210 is configured to be operated by a consumer. The exchange system includes without limitation an ad server 225 (or ad server system), the exchange entities 100 of FIG. 1A, a business platform 235 and a user interface 240. The ad server 225 is coupled to the exchange entities 100 and the business platform 235. The business platform 235 is coupled to the exchange entities 100 and the user interface 240. The business platform 235 carries out the more important operations of the system 200.

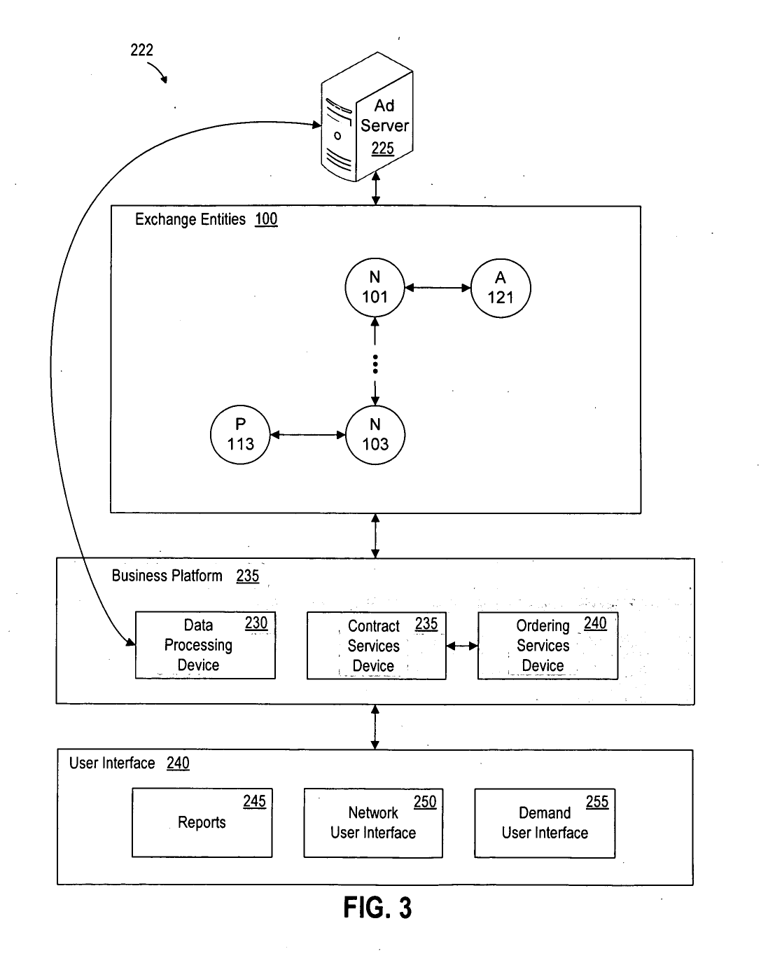

FIG. 3 is a more detailed block diagram of the exchange system 222 of FIG. 2, in accordance with an embodiment of the present invention. For explanatory purposes, FIG. 3 shows one path between the advertiser 121 and the publisher 113. However, the exchange entities 100 may include any number of paths, as described above with reference to FIG. 1A. The advertiser 121 (e.g., Nike®) may want to advertise with the publisher 113 (e.g., MercuryNews.com). The ad network 101 (e.g., Yahoo!® Ad Network) is authorized to deal and establish contracts on behalf of the advertiser 121. An ad network 103 is (e.g., MediaNews Group®) is authorized to deal and establish contracts on behalf of the publisher 113. As discussed above with reference to FIG. 1A, there may be any number of entities between the outer entities, the advertiser 121 and the publisher 113.

The business platform 235 includes without limitation a data processing device 230, a contract services device 235 and ordering services device 240. The data processing device 230 is in communication with the ad server 225. The contract services device 235 is in communication with ordering services device 240. The ad server 225 and the business platform have access to the exchange entities 100. The business platform 235 is in communication the user interface 240, which allows a user to manipulate operations of the business platform 235.

The user interface 240 includes without limitation a display capability for reports 245, a network user interface 250 and a demand user interface 255. The network user interface 250 allows a user to handle transactions with the contract services device 235. The demand user interface 255 allows a user to handle transactions with the ordering services device 240.

Contracts and/or Deals of Guaranteed Delivery

Still referring to FIG. 3, any two exchange entities on the exchange (who are linked to each other) can enter into an agreement to buy placements for guaranteed delivery. For example, the ad network 101 may enter into an agreement with the ad network 103 for advertiser 121 to buy placements for guaranteed delivery by publisher 113. This agreement is represented in the system as a guaranteed delivery enabling contract (GDE contract) and includes without limitation the price/revenue-share which will be paid to the seller by the buyer as a result of the guaranteed transaction, the terms and conditions agreed upon by both the buyer and the seller, and targeting controls and booking limits applicable to the GDE contract.

Guaranteed delivery includes certain special criteria, partially described here. The number of impressions must be available and reserved beforehand. Price is determined at ad reservation time. There is a stipulated time period within which all the promised impressions must be delivered. Also, it is possible to reserve guaranteed delivery on a “run-of” basis, meaning the ad serving system decides where to show the ad among multiple publishers.

Guaranteed delivery on the exchange fulfills the above criteria in the following manner. A path on the exchange is viable for guaranteed delivery only if there are valid GDE contracts on each edge of the path. A GDE contract is established along an edge by two entities agreeing on a contract for ad delivery or for some other related performance. At booking time, the business platform 235 determines all valid paths for guaranteed delivery. The valid paths originate from the buyer. The business platform 235 further trims the valid paths by matching the targeting controls defined on the GDE contract on the path with the targeting criteria defined on the campaign by the buyer. The business platform 235 then uses the valid paths to determine available inventory and make ad reservations.

The business platform 235 carries out several operations during the ad reservation process. During the ad reservation process, the business platform 235 determines the list of paths for which inventory is available. The business platform 235 handles “run-of” cases by determining paths to all publishers involved in the “run-of”. For each path, the business platform 235 pre-calculates price/revenue-share on each edge and records the information. Importantly, all the pre-computed information is tied together by the concept of a “booking”.

A booking represents a specific ad reservation for guaranteed delivery. A booking may encapsulate without limitation the advertiser on whose behalf the ad reservation is made, the campaign/order associated with the booking, the number of impressions reserved, the start/end date of the campaign/order, a pre-computed set of one or more paths on the exchange that are covered by the booking. Further, “run-of” ad reservations that cover several publishers will have more than one path. Each path represents the path to the publisher on the exchange. Regular ad reservations will have one path (path to the publisher on the exchange). Also, there is pre-computed price/revenue-share information for each edge of each path.

### Deal Tags of Guaranteed Delivery

Still referring to FIG. 3, in the context of guaranteed delivery on an advertising exchange, a publisher (seller of inventory) may wish to exercise various types of control over specific deals with advertisers (buyers of inventory). The business platform 235 allows for the configuration of at least four types of controls on each deal that a seller has with a buyer. The publisher uses the user interface 240 to create and configure the controls. A publisher may configure each control for a specific buyer or may be shared across multiple buyers.

The types of controls include without limitation targeting controls, delivery controls, booking limits and pricing controls. Targeting Controls allow a seller to control the types of targeting a buyer may do on their inventory. One targeting control may be “not allowed”, meaning the buyer may not do any targeting on this attribute. For example, the buyer may not do any geo-targeting. Another targeting control may be “allowed values”, meaning the buyer may target on this attribute, but may only choose from a restricted list of values. For example, the buyer may do geo-targeting but may only choose from five specified values. Yet another control may be “exact values”, meaning the buyer must target on a designated attribute, with specified values. For example, the buyer must geo-target a specific value.

Booking Limits allow a seller to place restrictions on the amount of inventory a buyer may reserve. Restrictions can be configured per publisher and per site, and for specific types of inventory. For example, the seller may specify that the buyer can only reserve 50% of the “Sports” content category available for a specific publisher.

Pricing controls allow a seller to set prices for inventory specific to the buyer. For example, the seller may specify that the buyer must pay at least X amount for a specific inventory (spots on a page).

Delivery controls allow a seller to specify which inventory is available to the buyer. Inventory can be opted in or out per publisher and per site, and for specific types of inventory. For example, the seller might specify that the “Sports” content category is opted-out for a specific site to prevent the buyer from accessing that inventory.

The business platform 235 carries out the targeting controls, the booking controls and the pricing controls at booking time. The business platform 235 carries out the delivery controls when an ad is actually delivered.

### Processing of Guaranteed Delivery

Still referring to FIG. 3, the ad server 225 (or ad server system), in conjunction with the business platform 235, uses the bookings to determine what ads are to be served. After a guaranteed ad is served on a publisher's site based on a booking, the ad server 225 (or ad serving system) throws events. Throwing an event involves the ad server 225 recording the event for a purpose such as auditing, billing reports, revenue share reports, financial reports, etc. These events include information that the business platform 235 pre-computed, as described above with reference to FIG. 3. This information includes without limitation each edge of the path to the publisher (as encapsulated in the booking), price/revenue-share information per edge (on a cost per impression basis).

Downstream systems use this information to do at least one of the following: accrue the money owed by one entity to another entity; accrue the money to be paid by one entity to another entity; provide rollup “revenue share” and “billing forecast” reports; generate invoices for entities that owe money to an ad network; and send payments to entities that an ad network owes.

### Method Outline of Guaranteed Delivery

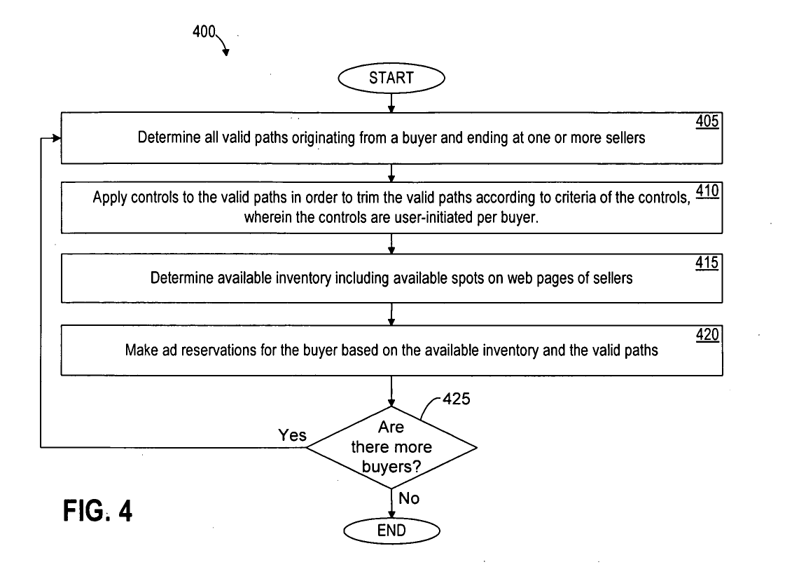

FIG. 4 is a flowchart of a method 400 for guaranteed delivery of ads on an exchange, in accordance with an embodiment of the present invention. The steps of the method 400 may be carried out by device of the business platform 435. The method 400 starts in step 405 where the system determines all valid paths originating from a buyer and ending at one or more sellers. A valid path is a path having established contracts between all adjacent intermediaries between a buyer and a seller, as discussed above with reference to FIG. 3.

The method 400 moves to step 410 where the system applies controls to the valid paths in order to trim the valid paths according criteria of the controls. These controls are user-initiated controls per buyer. Trimming the valid paths involves removing from consideration the valid paths that do not comport with criteria of the controls. Next, in step 415, the system determines available inventory for the buyer, wherein the available inventory includes available spots on web pages of sellers. For example, the business platform 435 receives the available inventory from the ad server 225 (or ad server system), which has information on all the available spots on pages of the sellers. Then, in step 420, the system makes ad reservations for the buyer based on the available inventory and the valid paths. Next, in decision operation 425, the system determines if there are any more buyers that seek to establish guaranteed delivery with a seller. If there are more buyers, the method 400 returns to step 405 and continues. However, if there are no more buyers, the method 400 is at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include without limitation device drivers, operating systems, and user applications. Ultimately, such computer readable media further includes software for performing the present invention, as described above.

Included in the programming (software) of the general/specialized computer or microprocessor are software modules for implementing the teachings of the present invention, including without limitation determining all valid paths originating from a buyer and ending at one or more sellers, applying one or more controls to the valid paths in order to trim the valid paths according to criteria of the one or more controls, determining available inventory including available spots on web pages of sellers, and making ad reservations for the buyer based on the available inventory and the valid paths, according to processes of the present invention.

### Advantages

The methods and apparatuses of the system guarantee delivery of ad creatives across an exchange. The system ensures that entities honor revenue-share amounts in a guaranteed way. The system ensures uniform semantics for billing and payment.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of guaranteed delivery of ads on an exchange, the method comprising:
determining all valid paths originating from a buyer and ending at one or more sellers;
applying one or more controls to the valid paths in order to trim the valid paths according to criteria of the one or more controls;
determining available inventory including available spots on web pages of sellers; and
making ad reservations for the buyer based on the available inventory and the valid paths.

2. The method of claim 1, wherein a valid path is a path having established contracts between all adjacent intermediaries between the buyer and a particular seller.

3. The method of claim 1, wherein applying the one or more controls comprises removing from consideration the valid paths that do no comport with criteria of the one or more controls.

4. The method of claim 1, wherein determining the available inventory comprises receiving information from an ad server about the available spots on pages of the sellers.

5. The method of claim 1, wherein the one or more controls include at least one of:
a targeting control;
a booking limit; and
a pricing control.

6. The method of claim 1, wherein an ad reservation is a booking for guaranteed delivery.

7. The method of claim 1, wherein an ad reservation encapsulates at least one of:
an identification of the buyer on whose behalf the ad reservation is made;
a campaign associated with the ad reservation;
an order associated with the ad reservation;
a number of impressions reserved for the buyer;
a start date;
an end date; and
a pre-computed set of one or more valid paths on the exchange that are covered by the ad reservation.

8. The method of claim 1, further comprising making run-of reservations that cover several publishers, wherein each run-of reservation has more than one valid path.

9. The method of claim 1, wherein the ad reservations are regular ad reservations, each regular ad reservation having one valid path.

10. The method of claim 1, wherein each valid path has one or more edges, wherein an edge is a connection between two adjacent entities of the valid path, wherein each edge is associated with at least one of:
pre-computed price information; and
pre-computed revenue share information.

11. A business platform apparatus for guaranteed delivery of ads on an exchange, wherein the business platform apparatus is configured for:
determining all valid paths originating from a buyer and ending at one or more sellers;
applying one or more controls to the valid paths in order to trim the valid paths according to criteria of the one or more controls;
determining available inventory including available spots on web pages of sellers; and
making ad reservations for the buyer based on the available inventory and the valid paths.

12. The business platform apparatus of claim 1, wherein a valid path is a path having established contracts between all adjacent intermediaries between the buyer and a particular seller.

13. The business platform apparatus of claim 1, wherein being configured for applying the one or more controls configures the business platform apparatus for removing from consideration the valid paths that do no comport with criteria of the one or more controls.

14. The business platform apparatus of claim 1, wherein being configured for determining the available inventory configures the business platform apparatus for receiving information from an ad server about the available spots on pages of the sellers.

15. The business platform apparatus of claim 1, wherein the one of more controls include at least one of:
a targeting control;
a booking limit; and
a pricing control.

16. The business platform apparatus of claim 1, wherein an ad reservation is a booking for guaranteed delivery.

17. The business platform apparatus of claim 1, wherein an ad reservation encapsulates at least one of:
an identification of the buyer on whose behalf the ad reservation is made;
a campaign associated with the ad reservation;
an order associated with the ad reservation;
a number of impressions reserved for the buyer;
a start date;
an end date; and
a pre-computed set of one or more valid paths on the exchange that are covered by the ad reservation.

18. The business platform apparatus of claim 1, where the business platform apparatus is further configured for making run-of reservations that cover several publishers, wherein each run-of reservation has more than one valid path.

19. The business platform apparatus of claim 1, wherein the ad reservations are regular ad reservations, each regular ad reservation having one valid path.

20. The business platform apparatus of claim 1, wherein each valid path has one or more edges, wherein an edge is a connection between two adjacent entities of the valid path, wherein each edge is associated with at least one of:
pre-computed price information; and
pre-computed revenue share information.

21. A computer readable medium carrying one or more instructions for guaranteed delivery of ads on an exchange, wherein the one or more instructions, when executed by one or more processors, cause the one or more processors to perform the steps of:
determining all valid paths originating from a buyer and ending at one or more sellers;
applying one or more controls to the valid paths in order to trim the valid paths according to criteria of the one or more controls;
determining available inventory including available spots on web pages of sellers; and
making ad reservations for the buyer based on the available inventory and the valid paths.
